(19) United States
(12) Patent Application Publication
(10) Pub. No.: US 2015/0077430 A1
(43) Pub. Date: Mar. 19, 2015

(54) IMAGING UNIFORMITY SYSTEM

(71) Applicant: CAPTUREPROOF, Inc., San Francisco, CA (US)

(72) Inventor: Meghan Conroy, San Francisco, CA (US)

(73) Assignee: CAPTUREPROOF, Inc., San Francisco, CA (US)

(21) Appl. No.: 14/486,248

(22) Filed: Sep. 15, 2014

Related U.S. Application Data
(60) Provisional application No. 61/877,288, filed on Sep. 13, 2013.

(51) Int. Cl. G06T 7/00; G09G 5/34; G09G 5/02; G09G 1/00; G09G 5/14; G06T 11/60

(52) U.S. Cl. CPC G06T 7/0012; G09G 5/14; G06T 11/60; G09G 5/026; G09G 1/007; G09G 5/34; G06T 2207/10016; G06T 2207/10004; G06T 2210/41; G06T 2207/30004
USPC 345/589; 345/641; 345/635

(57) ABSTRACT

An imaging uniformity method and apparatus can include: acquiring an initial image based on a protocol; generating a protocol guide based on the initial image; displaying the protocol guide overlaying an actual image; and acquiring a subsequent image of the actual image, and the subsequent image being in alignment with the protocol guide.

### CROSS-REFERENCE TO RELATED APPLICATIONS

This application claims the priority benefit, with regard to all common subject matter, of U.S. Provisional Patent Application Ser. No. 61/877,288, titled Image Acquisition, Replication and Comparison Methods using the Marking of Contour Tracing and Translucent Image Placement on Image Capturing Screen, of Previously Captured Images and Video for Mobile Applications and Phones and a Timeline Comparative Feature System and Method for Image Acquisition, Replication and Comparison, and filed on Sep. 13, 2013; this application is incorporated herein by reference in its entirety.

### TECHNICAL FIELD

This disclosure relates to the medical industry, more particularly to devices and methods for uniformly acquiring, replicating, sharing, and comparing still and motion images.

### BACKGROUND

In the medical field, diagnostic imaging techniques have become a critical technology relied upon by doctors around the world. Many imaging technologies like Video EEGs, X-rays, CT scanning, mammography and magnetic resonance imaging have greatly increased the standard of care and capability of doctors by enabling them to view structures within the human body that were not previously viewable except through invasive means.

These previously developed non-invasive imaging techniques have been instrumental in improving clinical safety and patient outcomes. High cost, however, is a major limitation in the application of the previously developed non-invasive imaging technologies, restricting their use by doctors and facilities as well as the patients who can benefit from them. These previously developed non-invasive imaging techniques have contributed to the rising costs of healthcare and many have long term detrimental effects on patients due to the high levels of radiation used in connection with such techniques.

Further, these previously developed non-invasive imaging techniques are not useful in medical arts such as dermatology where external visual imaging and analysis are the main diagnostic techniques. Skin ailments such as melanoma, for example, are often characterized through a doctor's visual analysis of the patient's skin. A doctor treating melanoma is primarily concerned with the size, color, and shape of the melanoma at a given time as well as how the size and shape of the melanoma are changing over time.

The previously developed non-invasive imaging techniques further fail to provide useful information in the cosmetics industry where research scientists must visually study how make-up, creams such as wrinkle and cellulite treatments, and other products affect the appearance of subjects over a period of time or course of treatment using such cosmetic products.

Additionally these previously developed non-invasive imaging techniques fail to provide useful information for researchers involved in clinical trials who must visually study certain experimental topical therapeutics to determine the efficacy of such therapeutics on patients suffering from various skin aliments. The results of such visual studies are then used to support regulatory filings with the goal of having such therapeutics approved for sale to consumers.

Since external visual imaging in the medical arts is primarily concerned with how certain structures on the human body are changing over time, both still and motion photography have become vital tools for image acquisition and storage. Such still and motion photography allows doctors and clinical researchers to study images taken at one time with images taken at a later time to assess how a patient's condition is changing as a function of time. However, the use of still and motion photography in the medical arts presents a unique set of challenges.

A primary challenge inherent in the use of still and motion photography is a potential lack of consistency during the acquisition and analysis of images. For example, non-uniform lighting conditions may make image comparison between two different photographs or video difficult. Another challenge arises during studies when pre-defined image acquisition protocols depend on correct and consistent patient position or posture. Image analysis and comparison is made more difficult when even slight position changes of the camera with respect to the subject occur between two different images.

Another challenge involves the photographic equipment itself. Bulky cameras, video cameras and lighting setups are expensive and difficult for medical practitioners (who in most cases are not trained photographers) to use in doctor's offices and other healthcare settings. Such equipment setups are also difficult to deploy and use consistently at multiple investigator sites when clinical trials are being performed. Still other challenges involve the lack of efficient systems and methods to store, retrieve and analyze images for the purposes of patient care.

These problems are compounded when untrained patients are tasked with taking subsequent pictures of the relevant limb, wound, rash, or any other physical presentation on their person in a uniform manner that allows effective analysis and diagnosis. Patients also have been found to encounter extreme difficulty when attempting to capture, on video, an accurately reproduced movement of timing and position that allows effective analysis and diagnosis.

Solutions have been long sought but prior developments have not taught or suggested any complete solutions, and solutions to these problems have long eluded those skilled in the art. Thus there remains a considerable need for devices and methods enabling users to accurately acquire uniform images in accordance with a protocol allowing effective analysis and diagnosis.

### SUMMARY

Contemplated embodiments of the imaging uniformity system can include methods and devices for acquiring an initial image based on a protocol; generating a protocol guide based on the initial image; displaying the protocol guide overlaying an actual image; and acquiring a subsequent image of the actual image, and the subsequent image being in alignment with the protocol guide.

The present disclosure includes contemplated steps of providing to the user, via a user interface, instructions in the form of a protocol guide for posing a subject according to a protocol, receiving, via an imaging apparatus, a first set of images and a second set of images taken in accordance with the protocol; storing, on a computer readable memory, the first set of images and the second set of images; providing for display, via the user interface, the first set of images and the second set of images of comparison purposes.

The present disclosure further includes the steps of providing to the user a translucent image and contour tracing of an initial image placed on the user interface of the imaging apparatus to enable the user to achieve similar positioning, orientation and placement of the relevant subject matter, in subsequent images of the patient. Additionally, a timeline comparative feature is disclosed enabling images within a protocol to be compared to one another, using a slider feature.

Accordingly it has been discovered that one or more embodiments described herein can provide research organizations, hospitals, universities, pharmaceutical companies, and medical device manufacturers a system to accurately acquire uniform images in accordance with a protocol allowing effective analysis and diagnosis.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The imaging uniformity system is illustrated in the figures of the accompanying drawings which are meant to be exemplary and not limiting, in which like reference numerals are intended to refer to like components, and in which:

FIG. 1 is an exemplary distributed computer system according to an embodiment of the imaging uniformity system.

FIG. 2 is the image-capturing device of FIG. 1 after an initial image capturing phase of operation.

FIG. 3 is the image-capturing device of FIG. 1 after an image standardization phase of operation.

FIG. 4 is the image-capturing device of FIG. 1 after a protocol guide generating phase of operation.

FIG. 5 is an isometric view of the image-capturing device of FIG. 1 in a distance adjustment phase of operation.

FIG. 6 is an isometric view of the image-capturing device of FIG. 1 in an aligned adjustment phase of operation.

FIG. 7 is an isometric view of the image-capturing device of FIG. 1 in an image capture phase of operation.

FIG. 8 is an isometric view of the image-capturing device of FIG. 1 in a moving image capture phase of operation.

FIG. 9 is a graphical depiction of an interface for a first embodiment of the imaging uniformity system.

FIG. 10 is a graphical depiction of an interface for a second embodiment of the imaging uniformity system.

FIG. 11 is an exemplary control flow for an embodiment of the imaging uniformity system.

FIG. 12 is an exemplary method of operation of the imaging uniformity system.

### DETAILED DESCRIPTION

In the following description, reference is made to the accompanying drawings that form a part hereof, and in which are shown by way of illustration, embodiments in which the imaging uniformity system may be practiced. It is to be understood that other embodiments may be utilized and structural changes may be made without departing from the scope of the imaging uniformity system.

The imaging uniformity system is described in sufficient detail to enable those skilled in the art to make and use the imaging uniformity system and numerous specific details are provided to give a thorough understanding of the imaging uniformity system; however, it will be apparent that the imaging uniformity system may be practiced without these specific details.

In order to avoid obscuring the imaging uniformity system, some well-known system configurations are not disclosed in detail. Likewise, the drawings showing embodiments of the system are semi-diagrammatic and not to scale and, particularly, some of the dimensions are for the clarity of presentation and are shown greatly exaggerated in the drawing FIGS. Generally, the imaging uniformity system can be operated in any orientation.

As used herein, the term system is defined as a device or method depending on the context in which it is used. The term image is generally used herein to describe a still image for descriptive clarity; however, the term image is intended to encompass a series of images as is found in a video or an image and changes thereto as is found in a compressed or encoded video.

The term protocol refers to a requirement for image acquisition. Example protocol can include: position of a patients body or body part with reference to an image capturing device such as posture, position, pose, angle, view; acquisition of an image according to a schedule such as day or time of day; lighting; subject; movement for video acquisition; acquisition of a secondary object like a pantone screen or a white piece of paper; the surface condition of a patient; or image-capturing device specifications like focal distance or shutter speed. These example protocols are not intended to be an exhaustive list. It is contemplated that these protocols can be used individually or in combination. It is further contemplated that other protocols not mentioned here can be implemented individually or in combination with the above listed example protocol.

The term parameter includes data about the image or the acquisition of the image. Example parameters can include time and date of acquisition, corrections for color balance of the image, aberrations between the image captured and the protocol, information about an image-capturing device, subject identification, user identification, provider, condition, or number of attempts by the user to capture the image within the required protocol. The term series as used herein refers to a group of images taken using a specific protocol.

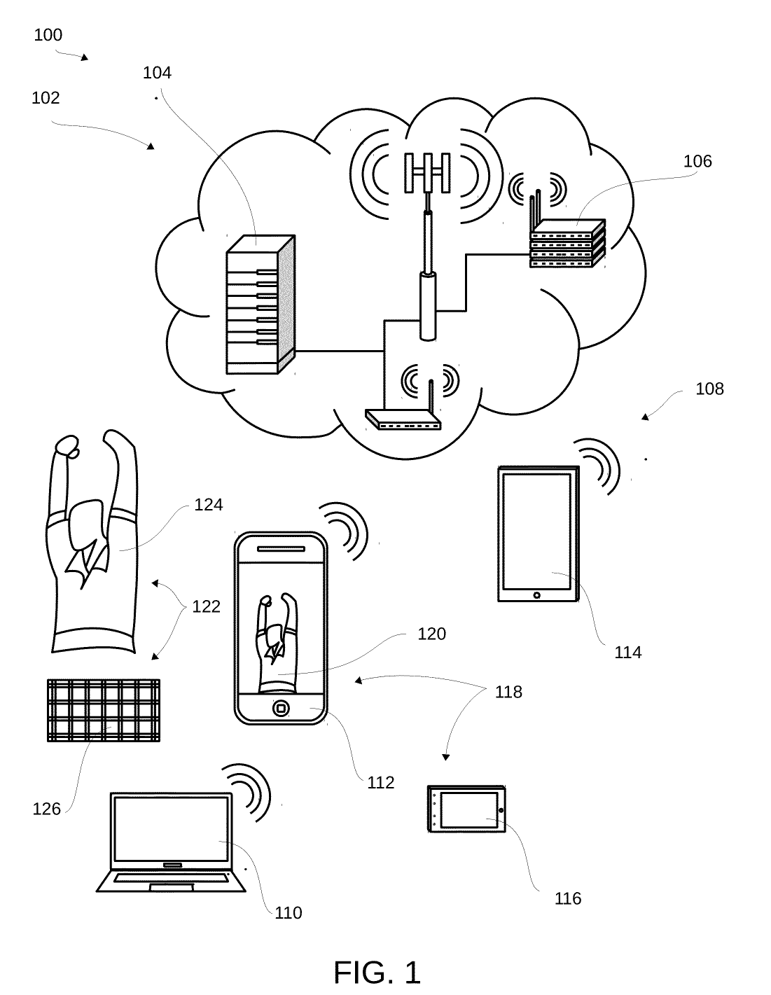

Referring now to FIG. 1, therein is shown an exemplary distributed computer system according to an embodiment of the imaging uniformity system 100. The imaging uniformity system 100 can include elements of a distributed computing system 102 including servers 104, routers 106, and other telecommunications infrastructure.

The distributed computing system 102 can include the Internet, a wide area network, (WAN), a metropolitan area network (MAN), a local area network (LAN), a telephone network, cellular data network (e.g., 3G, 4G) and/or a combination of these and other networks (wired, wireless, public, private or otherwise).

The servers 104 can function both to process and store data for use on user devices 108 including laptops 110, cellular phones 112, and tablet computers 114, and cameras 116. It is contemplated that the servers 104 and the user devices 108 can individually comprise a central processing unit, memory, storage and input/output units and other constituent components configured to execute applications including software suitable for displaying user interfaces, the interfaces optionally being generated by a remote server, interfacing with the cloud network, and managing or performing capture, transmission, storage, analysis, display, or other processing of data and or images.

The servers 104 and the user devices 108 of the imaging uniformity system 100 can further include a web browser operative for, by way of example, retrieving web pages or other markup language streams, presenting those pages or streams, executing scripts, controls and other code on those pages or streams, accepting user input with respect to those pages or streams, and issuing HTTP requests with respect to those pages or streams. The web pages or other markup language can be in HAML, CSS, HTML, Ruby on Rails or other conventional forms, including embedded XML, scripts, controls, and so forth as adapted in accord with the teachings hereof. The user devices 108 and the servers 104 can be used individually or in combination to store and process information from the imaging uniformity system 100 in the form of protocol, parameters, images, protocol instructions and protocol guides.

The user devices 108 can also be image-capturing devices 118, such as the cellular phone 112, the camera 116, the laptop 110, or the tablet computer 114. It is contemplated that the image-capturing device 118 can be any device suitable for acquiring images and communicating the images to the distributed computing system 102.

The image-capturing devices 118 can be used to capture and display images 120 of a subject 122. It is contemplated that the subject 122 can be a patient 124, a user (not shown), an object 126, pictorial representations such as photographs or drawings, images including DICOM images or X-ray images, and models. The object 126 is depicted as a pantone screen which can include many sample colors including black and white which can be used for color balance and lighting correction.

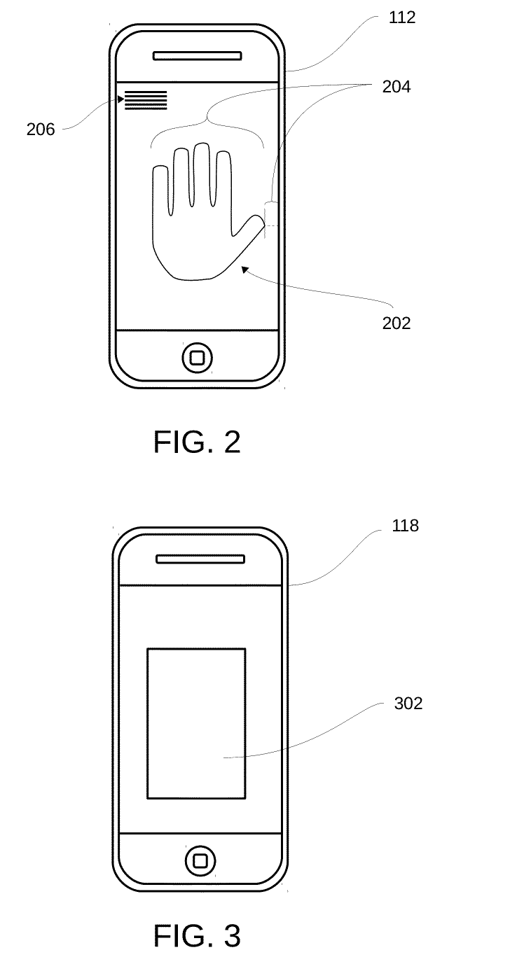

Referring now to FIG. 2, therein is shown the image-capturing device 118 of FIG. 1 after an initial image capturing phase of operation. The image-capturing device 118 can be the cellular phone 112 and is depicted displaying an initial image 202 acquired in accordance with a protocol 204.

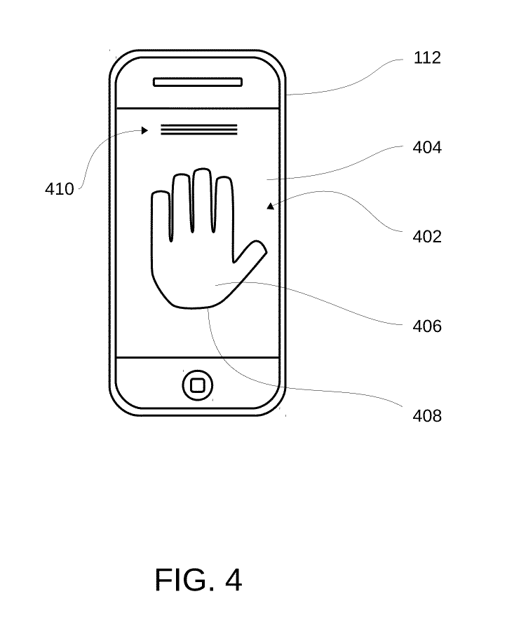

The initial image 202 is depicted here, and in the FIGS. that follow as a hand of the patient 124 of FIG. 1, for ease of descriptive only and the imaging uniformity system 100 of FIG. 1 is not intended to be limited by this illustrative description. As an illustrative example, the initial image 202 can be taken of photographs, videos, drawings, DICOM images, X-ray images, models, or a combination thereof and can be used to generate the protocol guide of FIG. 4 below. It is contemplated that the initial image 202 can be captured by a healthcare professional and then acquired by the imaging uniformity system 100 and stored on the distributed computing system 102 of FIG. 1 either in the servers 104 of FIG. 1 or on the user device 108 of FIG. 1.

It is further contemplated the protocol 204 can be defined in part by the initial image 202, that is the alignment, position, movement, angle, view, lighting, and size of the patient 124 in relation to the image-capturing device 118, when the initial image 202 was captured, can be incorporated in the protocol 204.

The protocol 204 can also be a standard set of requirements that will be implemented for each single patient 124 within a broader study or practice. The initial image 202 can be taken in compliance with the protocol 204 determined before the initial image 202 is captured for portions of the protocol 204 the initial image 202 is not used to generate.

As an illustrative example, the protocol 204 can be provided by a physician after examining a patient's 124 condition and determining the proper protocol 204 in terms of position with reference to the image-capturing device 118, and period between images for an individual patient 124. Other contemplated methods of determining the protocol 204 can include determining a standard position with reference to the image-capturing device 118, and period between images for multiple patients 124, which can be helpful when comparing many series of images for multiple patients 124 in situations like clinical trials.

Other elements of the protocol 204 can include a schedule for taking subsequent images, taking of control images, and movement. The image-capturing device 118 can further depict parameters 206. The parameters 206 can include metrics under which the initial image 202 was taken such as focal metrics, shutter metrics, lighting metrics, contrast metrics, and color metrics.

Referring now to FIG. 3, therein is shown the image-capturing device 118 of FIG. 1 after an image standardization phase of operation. The image-capturing device 118 is depicted having a control image 302 captured and displayed on a user interface of the image-capturing device 118.

The control image 302 will have been taken in the same environment and with the same image-capturing device 118 used to capture the patient 124 in FIG. 2. The control image 302 can be captured before or after the initial image 202 of FIG. 2 was taken. It has been discovered that capturing the control image 302 in the same environment as the initial image 202 enables an accurate measurement of the light and color metrics of the parameters 206 of FIG. 2.

The control image 302 can be taken of the object 126 and provide information about the environment and image-capturing device 118 used to capture the initial image 202 for analysis and color balance. The image 120 of FIG. 1 can be color balanced by a processor located on the distributed computing system 102 of FIG. 1 either in the servers 104 of FIG. 1 or on the user device 108 of FIG. 1. The control image 206 can be used to correct the color, lighting, and other image aspects of the initial image 202 as well as a subsequent image (described in greater detail below) by taking the control image 302 in the same environment and immediately before or after the initial image 202 or a subsequent image, which is used to provide uniform and reproducible light parameters.

Referring now to FIG. 4, therein is shown the image-capturing device 118 of FIG. 1 after a protocol guide generating phase of operation. The image-capturing device 118 can be the cellular phone 112 having a protocol guide 402 displayed on a user interface 404 of the cellular phone 112. It is contemplated the user interface 404 could include any type of screen, or visual interface.

The protocol guide 402 can include a translucent image 406, a contour 408, or a combination thereof. The contour 408 and the translucent image 406 are contemplated to act as a guide to a user for conforming to the protocol 204 of FIG. 2 by indicating, in a graphical depiction, various aspects of the protocol such as the distance and position of a subject 122 of FIG. 1 in relation to the image-capturing device 118.

The protocol guide 402 can further include instructions 410. The instructions 410 are contemplated to be communications to the user or the patient 124 of FIG. 1 for conforming to the protocol 204. Examples of the instructions 410 can be: “Please share videos of your son's next two seizures with me. Please be sure to mention what you think triggered his seizures.” The instructions 410 are depicted as written instructions but it is contemplated the instructions could include video or audio instructions 410.

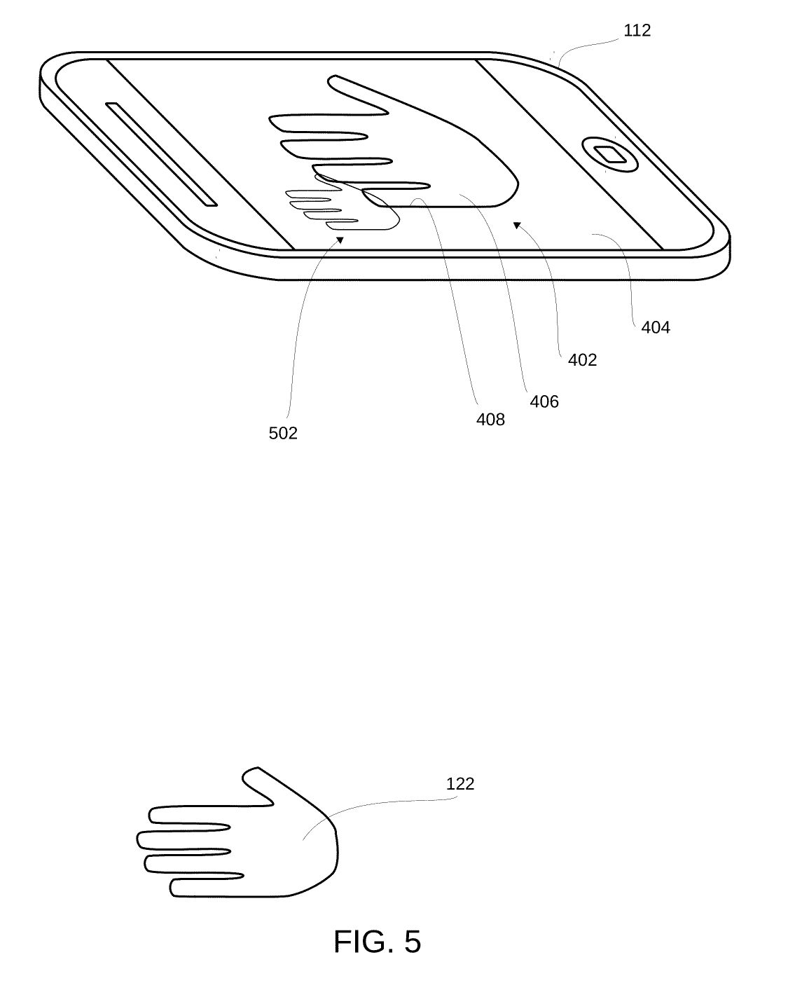

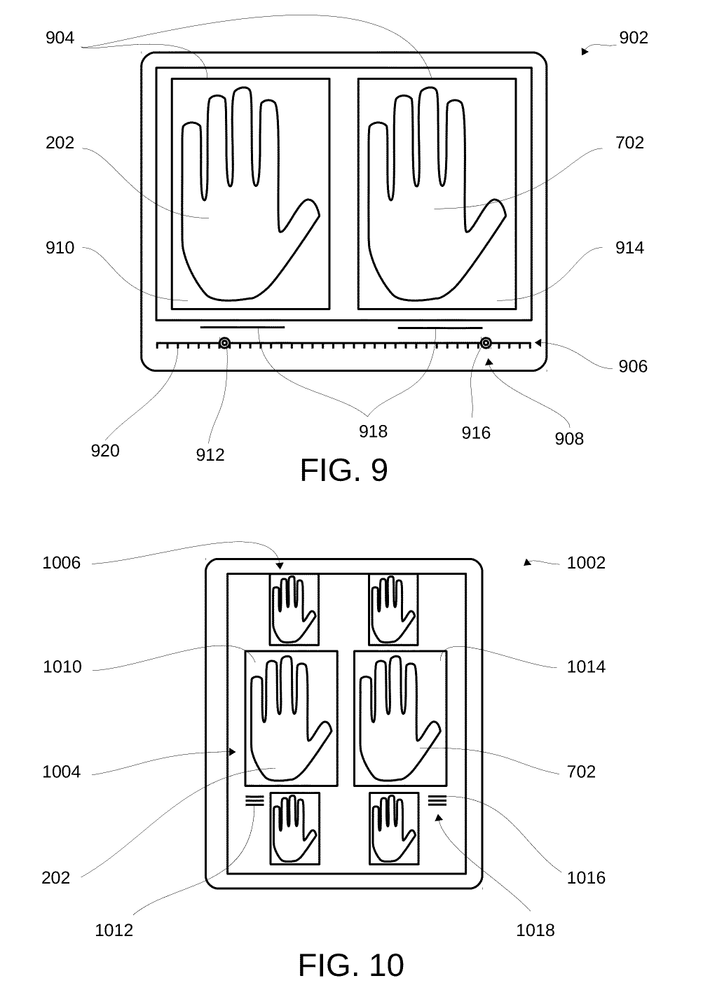

The instructions 410 are depicted as displayed on the user interface 404 along with the translucent image 406 and the contour 408 but without an actual image 502 of FIG. 5 of the subject 122. It is contemplated that the instructions 410 can be overlaid on the actual image 502 of the subject 122 or alternatively can be displayed on a review screen like those of FIG. 9 or 10.

The contour 408 is depicted as an outline of the hand from the initial image 202 of FIG. 2 of the subject 122. The contour 408 can be generated from the initial image 202 by pixel shade, color, or intensity comparison.

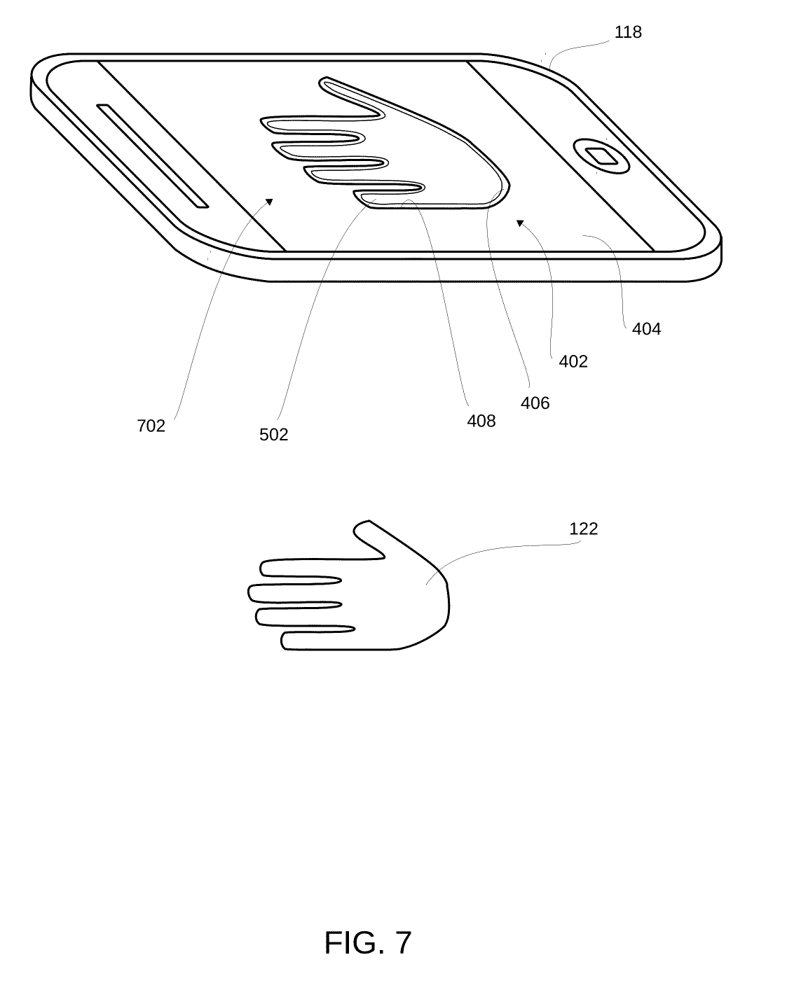

In other contemplated embodiments the contour 408 can be generated by subsequent images rather than the initial image 202 to maintain an up-to-date protocol guide 402 for the subject 122 even if the subject's outline changes over time. As an illustrative example, a user or healthcare professional might be presented with the option to select any of the images 120 of FIG. 1 including the initial image 202, or any of the subsequent images of FIG. 7 below. Further it is contemplated that the contour 408 could include more than simply the outline of the subject 122 but could also include topographical details such as marks on the skin of the subject 122.

In the present depiction of the contour 408 in FIG. 4, the contour 408 is shown slightly larger than the actual hand of the subject 122 in FIG. 2 and is depicted bolder. The contour 408 can further be shaded a color that contrasts with the initial image 202 or any subsequent image for ease of use. It is contemplated that the contour 408 could change color during use based on the environment the contour 408 is superimposed on.

The contour 408 can be emphasized, highlighted, magnified, or accentuated differently from the rest of the initial image 202 or any subsequent image that it is superimposed on. The translucent image 406 can be created from the initial image 202 as a translucent reproduction or a semitransparent reproduction.

In the present illustrative example, the translucent image 406 is the hand of the subject 122, while the contour 408 provides an indication of the outer edge of the hand of the subject 122. The contour 408 can be displayed lighter or darker than the translucent image 406 of the initial image 202. It is contemplated that the contour 452 or the translucent image 406 can be used to signal a match or alignment between the subsequent image and the protocol 204 by flashing, changing color, or other suitable means.

Referring now to FIG. 5, therein is shown an isometric view of the image-capturing device 118 of FIG. 1 in a distance adjustment phase of operation. The image-capturing device 118 can be the cellular phone 112 but can also be other image-capturing devices 118.

The cellular phone 112 is shown having the protocol guide 402 displayed on the user interface 404. The protocol guide 402 is depicted having the contour 408 as a darker bolded outline of the initial image 202 of FIG. 2. Within the contour 408, the translucent image 406 can be reproduced.

The contour 408 and the translucent image 406 overlay an actual image 502 of the subject 122. The actual image 502 will be used to describe the image of the subject 122 displayed on the user interface 404 before a subsequent image is saved. The subsequent image will be used to describe an image that is saved in the series of a protocol after the initial image 202.

It is contemplated that the translucent image 406 and the contour 408 of the protocol guide 402 can be dynamically adjusted based on the lighting, color, background, or other parameters 206 of the actual image 502. The dynamic adjustment of the translucent image 406 or the contour 408 can include making the translucent image 406 or contour 408 lighter or darker, more or less transparent, colored or highlighted a contrasting color, or even pulsating.

It is contemplated that the translucent image 406 and the contour 408 can be dynamically adjusted independent of each other. It has been discovered that dynamically adjusting the translucent image 406 or the contour 408 ensures that the protocol guide 402 will act as an overlay always allowing the actual image 502 of the subject 122 to appear on the user interface 404 without being obstructed by the protocol guide 402.

The actual image 502 is depicted as misaligned and too far away from the image-capturing device 118 represented by the actual image 502 being misaligned with the contour 408 of the protocol guide 402 representing the positional protocol 204 of FIG. 2. The misaligned actual image 502 indicates that the subject 122 is not positioned properly relative to the image-capturing device 118.

The misaligned actual image 502 could indicate that the image-capturing device 118 or the subject should be moved horizontally, vertically, rotated, angled, or posed in a different way so as to conform to the protocol 204. The actual image 502 is further depicted as too small relative to the contour 408 of the protocol guide 402.

When the actual image 502 is smaller than the contour 408 the image-capturing device 118 should be repositioned closer to the subject 122. It is contemplated in some embodiments that the contour 408 would be slightly larger than the subject 122 to avoid obscuring the outline of the actual image 502 or that the contour 408 would be slightly transparent so that the outline of the actual image 502 can be seen through the contour 408.

It has been discovered that projecting or overlaying the protocol guide 402 including the contour 408 or the translucent image 406 on the user interface 404 of the image-capturing device 118 enables the users to intuitively and accurately take an image of their relevant body part, symptom, or presentation with a high degree of compliance with the protocol 204 and providing a similar positioning, alignment, orientation and presentation to the initial image 202. It has further been discovered that implementing the protocol guide 402 on the user interface 404 of a device allows a user or the subject 122 to progressively align their body part in compliance with the protocol 204.

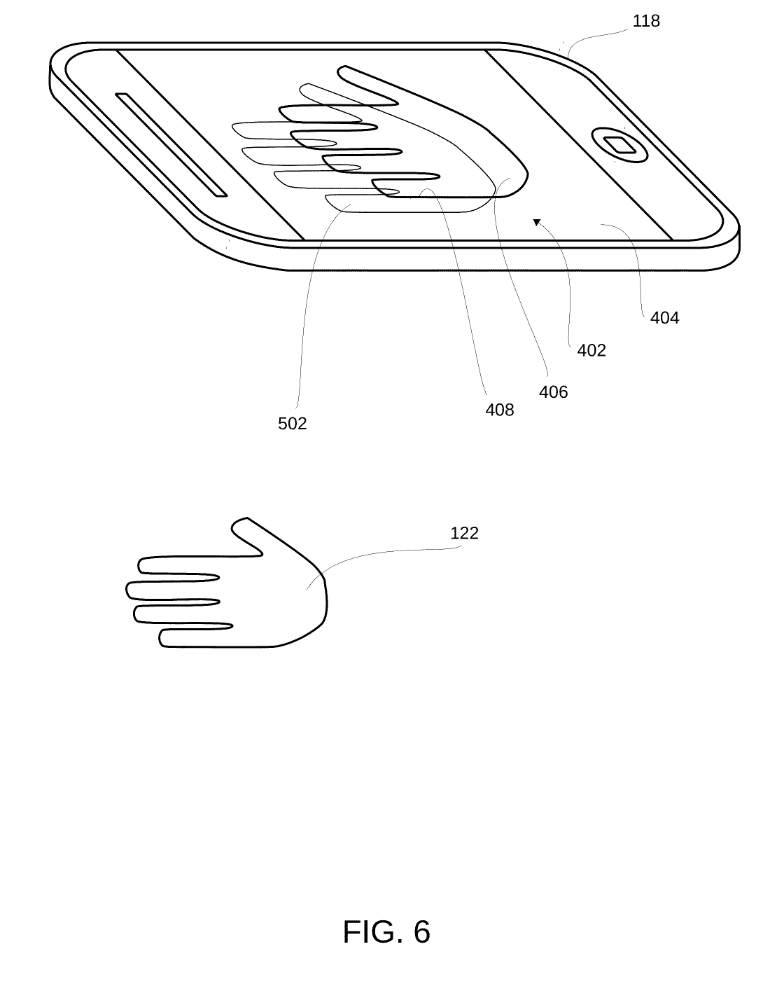

Referring now to FIG. 6, therein is shown an isometric view of the image-capturing device 118 of FIG. 1 in an aligned adjustment phase of operation. The subject 122 is shown closer to the image-capturing device 118 than the subject 122 was in the previous FIG. 5. As a result, the actual image 502, identified by the lighter tracing, is shown as nearly the same size as the contour 408 of the protocol guide 402 on the user interface 404 of the image-capturing device 118.

Within the contour 408, the translucent image 406 is shown allowing the actual image 502 to show through the protocol guide 402 for ease of alignment. Further, the actual image 502 is shown as misaligned with the contour 408 of the protocol guide 402 indicating a vertical or horizontal change between the image-capturing device 118 and the subject 122 is required to more closely conform with the protocol 204 of FIG. 2.

Referring now to FIG. 7, therein is shown an isometric view of the image-capturing device 118 of FIG. 1 in an image capture phase of operation. The image-capturing device 118 is depicted having the actual image 502 aligned with the protocol guide 402 on the user interface 404.

Specifically, the actual image 502 that depicts the hand of the subject 122 is shown within the contour 408 of the protocol guide 402. In the present exemplary embodiment and for ease of description, the actual image 502 is shown slightly within the contour 408 signaling compliance with the protocol 204 of FIG. 2; however, it is contemplated that the actual image 502 could overlap with the contour 408 in order to signal compliance with the contour 408 in other embodiments.

The actual image 502 is shown appearing through the translucent image 406 of the protocol guide 402 for ease of alignment with the protocol guide 402. It is contemplated that the contour 408 or the translucent image 406 can be used to signal a match or alignment between the actual image 502 and the protocol guide 402 by flashing, changing color, or other suitable means.

Upon compliance between the actual image 502 and the protocol guide 402 is obtained by the user, the user can capture the actual image 502 as a subsequent image 702. The subsequent image 702 will be compliant with the protocol 204 dictating position, posture, and pose, so long as the actual image 502 is in alignment with the protocol guide 402. It is contemplated that the subsequent image 702 can be captured by the patient 124, a user, or a healthcare professional and then acquired by the imaging uniformity system 100 of FIG. 1 and stored on the distributed computing system 102 of FIG. 1 either in the servers 104 of FIG. 1 or on the user device 108 of FIG. 1.

It has been discovered that aligning the actual image 502 with the protocol guide 402 results in the ability to easily capture the subsequent image 702 that is compliant with the protocol 204 and when the subsequent image 702 is compliant with the protocol 204, the subsequent image 702 and the initial image 202 of FIG. 2 are readily comparable. It is contemplated that the user can capture the subsequent image 702 when the actual image 502 aligns with the protocol guide 402 or the image-capturing device 118 can automatically capture the subsequent image 702 when the actual image 502 aligns with the protocol guide 402.

It is contemplated the subsequent image 702 can be used to further refine the protocol guide 402 if for example the subject 122 is changing size during the period of time the protocol 204 requires the subsequent images 702 to be taken such as during weight loss, and swelling or the reduction thereof. It is also contemplated that the protocol guide 402 based on the initial image 202 can continue to be used.

It is contemplated that before the subsequent image 702, or after the subsequent image 702 is taken, the control image 302 of FIG. 3 could be taken of the object 126 of FIG. 1. It is contemplated that the control image 302 could be taken in the same place with the same environmental factors, such as lighting, shadows, distance, image-capturing device 118, singularly or in combination.

Capturing the control image 302 enables the imaging uniformity system 100 to adjust the subsequent image 702 for color, lighting, contrast, and other image characteristics providing a high degree of similarity between the subsequent image 702 and the initial image 202. It has been discovered that adjusting the subsequent image 702 using the control image 302 provides a fast intuitive and accurate method of analysis and diagnosis.

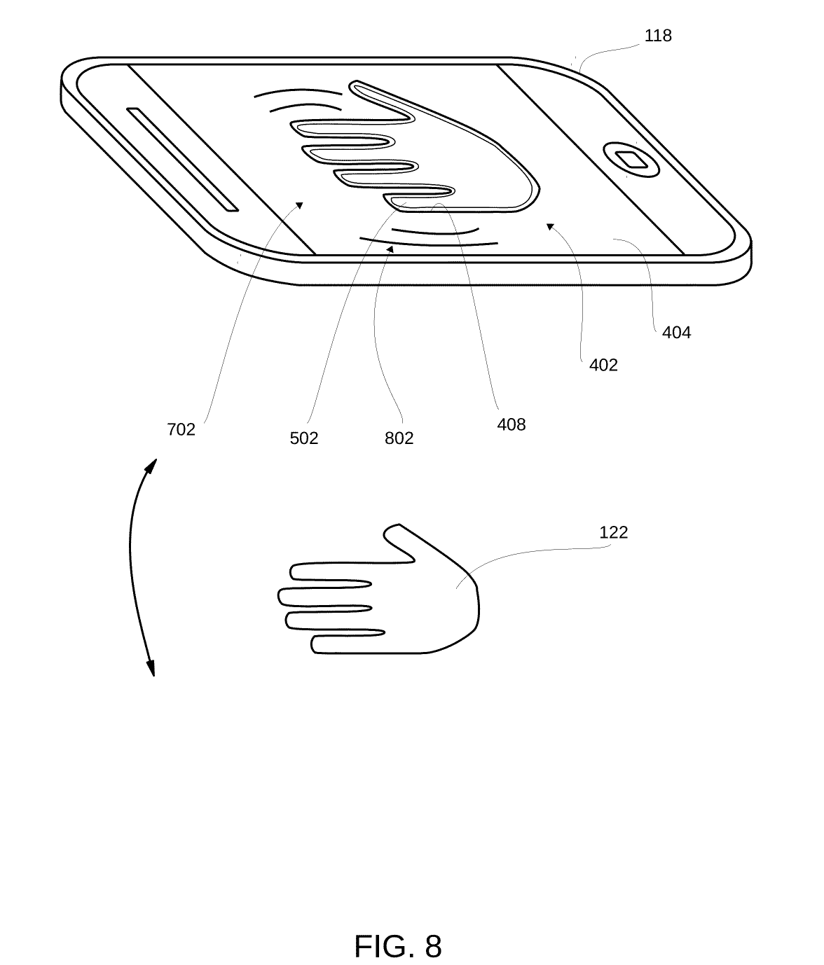

Referring now to FIG. 8, therein is shown an isometric view of the image-capturing device 118 of FIG. 1 in a moving image capture phase of operation. The image-capturing device 118 is depicted displaying the protocol guide 402 on the user interface 404 having the actual image 502 of the subject 122 aligned with the contour 408 similar to that of FIG. 7.

In the present depiction, however, the protocol guide 402 includes a further attribute of movement 802. The protocol guide 402 can provide a guide for the movement 802 of the subject 122 that is captured as the subsequent image 702 in the form of a video.

It is contemplated that the initial image 202 could also be in the form of a video and the contour 408 could be created from the initial image 202 similar to that of FIG. 4 but would have the additional attribute of the movement 802. The movement 802 of the contour 408 can be created in much the same way as the contour 408 of FIG. 7, that is for example, generated from the initial image 202 by pixel shade, color, or intensity comparison from each image in a video.

In the same way the subsequent image 702 of FIG. 7 is contemplated to be taken together with the control image 302 of FIG. 3, the subsequent image 702 representing a video of FIG. 8 is also contemplated to be captured along with a control image 302. The control image 302 can be used by the imaging uniformity system 100 to correct the video for color, lighting, contrast, and other image characteristics providing a high degree of similarity between the subsequent image 702 representing a video and the initial image 202 representing a video.

Referring now to FIG. 9, therein is shown a graphical depiction of an interface 902 for a first embodiment of the imaging uniformity system 100 of FIG. 1. The interface 902 is depicted having comparison panes 904, a timeline 906, and sliders 908.

The comparison panes 904 can include the initial image 202 or any of the subsequent images 702 from a series taken within the protocol 204 of FIG. 2 displayed on the user interface 404 of FIG. 4. The sliders 908 can be manipulated to change the images 120 of FIG. 1 displayed within the comparison panes 904, thus scrolling through the timeline 906, by moving them along the timeline 906.

The comparison panes 904 are shown without the protocol guide 402 of FIG. 4 displayed therein, but only the initial image 202 or the subsequent images 702. It has been discovered that taking the initial image 202 or the subsequent images 702 in accordance with the protocol 204 and aided by the protocol guide 402 provides the initial image 202 or the subsequent images 702 with similar in lighting, color, focus, and other image 120 characteristics for display in a way that greatly increases the ability of physicians to diagnose and analyze the patient 124 of FIG. 1. It is contemplated that the user will be able to zoom, filter, perform motion tracking or analysis, perform image segmentation, and perform other control or analysis functions on the image 120 on both of the comparison panes 904 identically and simultaneously by controlling only one of the comparison panes 904.

It has been further discovered that implementing the comparison panes 904 providing either the initial image 202 or the subsequent images 702 side-by-side enables physicians to quickly identify differences or changes in the condition of the patient 124 over time. Enabling a physician to identify changes over time greatly increases the ability of physicians to identify patterns or trends and take meaningful corrective action or make meaningful predictions.

It is contemplated that the sliders 908 could interact intuitively enabling a user to quickly display before and after images 120 of the subject 122 of FIG. 1. For instance, if a left pane 910 of the comparison panes 904 shows one of the subsequent images 702 taken at a first time 912, one of the subsequent images 702 or the initial image 202 depicted on the right pane 914 could be changed by moving the slider 908, associated with the right pane 914, along the timeline 906 displaying one of the subsequent images 702 taken at a second time 916 before or after the subsequent image 702 of the first time 912 displayed on the left pane 910.

It is contemplated that the sliders 908 could be locked in a plus or minus one configuration or could move independently of each other. It is further contemplated that the first time 912 and the second time 916 could always be different meaning the sliders 908 would jump over each other to the next image 120.

Further it is contemplated that the comparison panes 904 could operate as before or after panes. In this contemplated function one of the panes, such as the left pane 910 could always display either the initial image 202 or the subsequent images 702 of the first time 912 that is before any of the subsequent images 702 of the second time 916 displayed on the right pane 914.

It is contemplated that when the comparison panes 904 operate as before or after panes, when the slider associated with the left pane 910 hits the slider associated with the right pane 914 the slider associated with the right pane 914 could be locked in place or could move ahead to the next subsequent image 702 in the series of the protocol 204. Below the comparison panes 904, information 918 about the images 120 displayed on the comparison panes 904 can be viewed.

The information 918 can include the date and time the image 120 was taken in accordance with the protocol 204. Further the information 918 can include the position, pose, subject's 122 identity, previous diagnosis information, treatments or corrective actions taken after the image 120 was taken, along with any other information 918 that would be important to understanding the series of images 120 taken of the patient 124 and providing analyses and diagnoses.

It has been discovered that implementing the comparison panes 904 with the ability to easily display the information 918 and the images 120 from the first time 912 and the second time 916 allow a user to make diagnoses, assess healing or growth, assess beauty characteristics, or perform one or more analyses on the captured image data. This can also allow the user to view any combination of before and after images, provided that the images being compared were taken at different times.

The timeline 906 can further include time marks 920 or other indicators that one of the images 120 was taken at a date or time along the timeline 906. As noted above, the images 120 displayed within the comparison panes 904 could include still images or video.

When the comparison panes 904 are used to display video, it is contemplated that the video on the left pane 910 will play at the same time as the video on the right pane 914. It is contemplated that when the videos are played simultaneously on the comparison panes 904, the movement captured in accordance with the protocol 204 will be synchronized.

That is, when the video taken at the first time 912 displayed in the left pane 910 depicts the subject 122 moving to the left then to the right, the video taken at the second time 916 displayed in the right pane 914 will depict the subject 122 moving to the left then to the right at the same time. It is contemplated that the user will be able to pause, slow the video down, fast forward, rewind, zoom, or preform other video control functions on the video displayed on both of the comparison panes 904 identically.

Referring now to FIG. 10, therein is shown a graphical depiction of an interface 1002 for a second embodiment of the imaging uniformity system 100 of FIG. 1. The interface 1002 is depicted having comparison panes 1004, and a timeline 1006.

The comparison panes 1004 can include the initial image 202 or any of the subsequent images 702 from a series taken within the protocol 204 of FIG. 2. The timeline 1006 can be a vertical series of the images 120 of FIG. 1 that depicts one of the images 120 within the comparison panes 1004 and other images 120 captured before and after the image 120 displayed in the comparison panes 1004 above and below the comparison panes 1004, respectively.

The image 120 shown in the comparison panes 1004 is shown much larger for analysis and diagnosis purposes than the images 120 depicted above and below the comparison panes 1004. When a user wishes to advance the image 120 shown in the comparison panes 1004, the user can scroll through the timeline 1006 and display other images 120 of FIG. 1 within the series by simply swiping the timeline 1006 associated with a left pane 1010 or right pane 1014 up or down.

It is contemplated that the timeline 1006 could be reduced or expanded providing more or fewer images 120 above and below the comparison panes 1004. That is, the timeline 1006 could be eliminated completely leaving only the comparison panes 1004 left. A user would then simply swipe up, down, left, or right on the comparison panes 1004 to advance the image 120 displayed in the comparison panes 1004.

The comparison panes 1004 are shown without the protocol guide 402 of FIG. 4 displayed therein, but only the initial image 202 or the subsequent images 702. It has been discovered that taking the initial image 202 or the subsequent images 702 in accordance with the protocol 204 and aided by the protocol guide 402 provides the initial image 202 or the subsequent images 702 with similar in lighting, color, focus, and other image 120 characteristics for display in a way that greatly increases the ability of physicians to diagnose and analyze the patient 124 of FIG. 1. It is contemplated that the user will be able to zoom, filter, perform motion tracking or analysis, perform image segmentation, and perform other control or analysis functions on the image 120 on both of the comparison panes 1004 identically and simultaneously by controlling only one of the comparison panes 1004.

It has been further discovered that implementing the comparison panes 1004 providing either the initial image 202 or the subsequent images 702 side-by-side enables physicians to quickly identify differences or changes in the condition of the patient 124 over time. Enabling a physician to identify changes over time greatly increases the ability of physicians to identify patterns or trends and take meaningful corrective action or make meaningful predictions.

It is contemplated that the changing the images 120 displayed in the comparison panes 1004 could intuitively enable a user to quickly display before and after images 120 of the subject 122 of FIG. 1. For instance, if the left pane 1010 of the comparison panes 1004 shows one of the subsequent images 702 taken at a first time 1012, one of the subsequent images 702 or the initial image 202 depicted on the right pane 1014 could be changed by swiping the timeline 1006, associated with the right pane 1014, up or down displaying one of the subsequent images 702 taken at a second time 1016 before or after the subsequent image 702 of the first time 1012 displayed on the left pane 1010.

It is contemplated that the comparison panes 1004 could be locked in a plus or minus one configuration or could be changed independently of each other. It is further contemplated that the first time 1012 and the second time 1016 could always be different meaning the right pane 1014 and the left pane 1010 would not display the images 120 having the same first time 1012 or second time 1016 but instead would advance past to the next image 120 in the timeline 1006.

Further it is contemplated that the comparison panes 1004 could operate as before or after panes. In this contemplated function one of the panes, such as the left pane 1010 could always display either the initial image 202 or the subsequent images 702 of the first time 1012 that is before any of the subsequent images 702 of the second time 1016 displayed on the right pane 1014.

It is contemplated that when the comparison panes 1004 operate as before or after panes, the first time 1012 of the image 120 on the left pane 1010 will not be allowed to advance beyond the second time 1016 of the image 120 associated with the right pane 1014. Instead, the image 120 on the right pane 1014 would need to be advanced first before the image 120 on the left pane 1010 would be allowed to advance or move ahead to the next subsequent image 702 in the series of the protocol 204.

It is contemplated that either the left pane 1010 or the right pane 1014 might be operated as the before plane and the other pane operate as the after pane depending on the needs of the reviewer. Below the comparison panes 1004, information 1018 about the images 120 displayed on the comparison panes 1004 can be viewed.

The information 1018 can include the date and time the image 120 was taken in accordance with the protocol 204. Further the information 1018 can include the position, pose, subject's 122 identity, previous diagnosis information, treatments or corrective actions taken after the image 120 was taken, along with any other information 1018 that would be important to understanding the series of images 120 taken of the patient 124 and providing analyses and diagnoses.

It has been discovered that implementing the comparison panes 1004 with the ability to easily display the information 1018 and the images 120 from the first time 1012 and the second time 1016 allow a user to make diagnoses, assess healing or growth, assess beauty characteristics, or perform one or more analyses on the captured image data. This can also allow the user to view any combination of before and after images, provided that the images being compared were taken at different times.

As noted above, the images 120 displayed within the comparison panes 1004 could include still images or video. When the comparison panes 1004 are used to display video, it is contemplated that the video on the left pane 1010 will play at the same time as the video on the right pane 1014. It is contemplated that when the videos are played simultaneously on the comparison panes 1004, the movement captured in accordance with the protocol 204 will be synchronized.

That is, when the video taken at the first time 1012 displayed in the left pane 1010 depicts the subject 122 moving to the left then to the right, the video taken at the second time 1016 displayed in the right pane 1014 will depict the subject 122 moving to the left then to the right at the same time. It is contemplated that the user will be able to pause, slow the video down, fast forward, rewind, zoom, or perform other video control functions on the video displayed on both of the comparison panes 1004 identically.

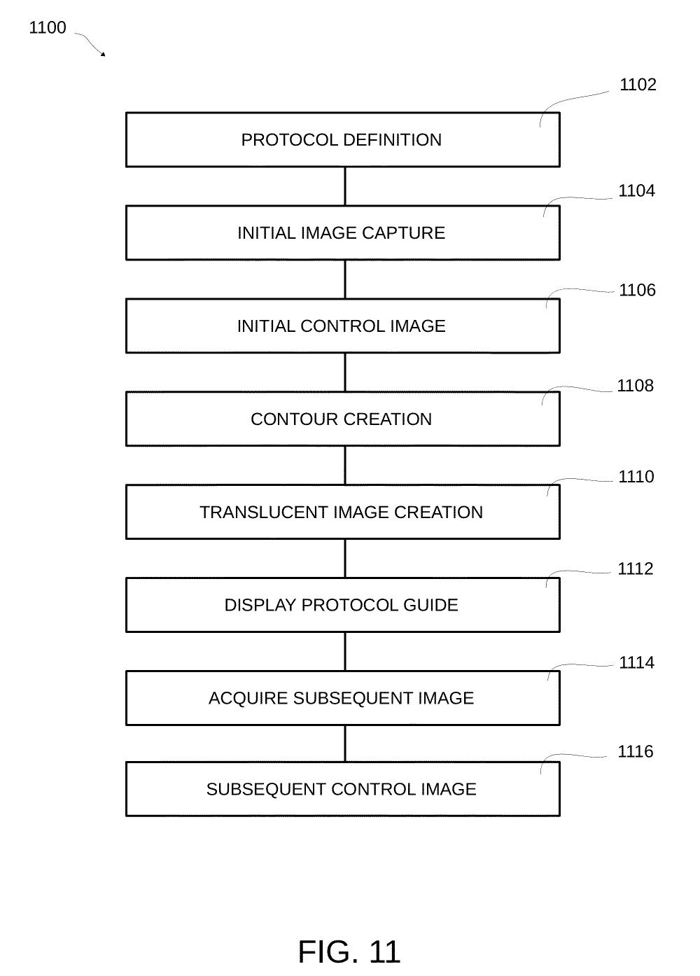

Referring now to FIG. 11, therein is shown an exemplary control flow 1100 for an embodiment of the imaging uniformity system 100 of FIG. 1. In general, the routines executed to implement the embodiments of the imaging uniformity system 100, may be part of an operating system or a specific application, component, program, module, object, or sequence of instructions.

The computer program of the imaging uniformity system 100 typically is comprised of a multitude of instructions that will be translated by the native computer into a machine-readable format and hence executable instructions. Also, programs are comprised of variables and data structures that either reside locally to the program or are found in memory or on storage devices.

In addition, various programs described hereinafter may be identified based upon the application for which they are implemented in a specific embodiment of the invention; however, it should be appreciated that any particular program nomenclature that follows is used merely for convenience, and thus the imaging uniformity system 100 should not be limited to use solely in any specific application identified or implied by such nomenclature.

Embodiments of the imaging uniformity system 100 may also be practiced in distributed computing environments in which tasks are performed by remote processing devices that are linked through a communications network. In a distributed computing environment, program modules may be located in both local and remote memory storage devices and data processing can be accomplished with both local and remote devices.

The following description includes the term module which is intended to include, but is not limited to, one or more computers configured to execute one or more software programs configured to perform one or more functions, operations or actions. It is contemplated that modules of the control flow 1100 could be deleted, combined, or rearranged without departing from the imaging uniformity system 100.

The control flow 1100 is depicted having a protocol definition module 1102. The protocol definition module 1102 includes the steps of defining the protocol 204 of FIG. 2. Coupled to the protocol definition module 1102 is an initial image capture module 1104 where the initial image 202 of FIG. 2 is first acquired by the imaging uniformity system 100 according to the protocol 204 defined in the protocol definition module 1102 and stored in a memory storage on the distributed computing system 102 of FIG. 1 either in the servers 104 of FIG. 1 or on the user device 108 of FIG. 1.

It is contemplated that the protocol definition module 1102 and the initial image capture module 1104 could overlap in some cases where the protocol 204 is defined in part by the initial image 202. Once the protocol 204 is defined in the protocol definition module 1102, the protocol 204 is stored within the distributed computing system 102 either on the user device 108 or the servers 104.

The initial image 202 can be stored on the distributed computing system 102 either in the servers 104 or on the user device 108. Coupled to the initial image capture module 1104 is an initial control image module 1106. The initial control image module 1106 includes acquiring the control image 302 of FIG. 3 in the same environment and close in time to the initial image 202 captured in the initial image capture module 1104.

It is contemplated that the initial control image module 1106 can be placed before the initial image capture module 1104 or after. The initial control image module 1106 can capture the control image 302 for color balancing the initial image 202. The corrections made to the initial image 202 with the control image 302 can be stored on the distributed computing system 102 either in the servers 104 or on the user device 108 for later analysis and manual color balancing.

Coupled to the initial control image module 1106 is a contour creation module 1108. In the contour creation module 1108 the contour 408 of FIG. 4 can be created using the methods described above and stored on the distributed computing system 102 either in the servers 104 or on the user device 108. The contour 408 can be generated in the contour creation module 1108 using either the initial image 202 before it is color balanced with the control image 302 or after.

It is contemplated that the contour creation module 1108 can be implemented before the initial control image module 1106 or after the initial control image module 1106. Coupled to the contour creation module 1108 is a translucent image creation module 1110. During the translucent image creation module 1110 the translucent image 406 of FIG. 4 is created by reducing the opacity of the initial image 202 captured in the initial image capture module 1104.

The translucent image 406 can be stored on the distributed computing system 102 either in the servers 104 or on the user device 108. It is contemplated that the translucent image creation module 1110 can be implemented before, during, or after the contour creation module 1108. It is further contemplated that the contour creation module 1108 and the translucent image creation module 1110 can be accomplished using processors on either the servers 104 or the user devices 108.

The protocol guide 402 of FIG. 4 including the translucent image 406 generated in the translucent image creation module 1110 along with contour 408 generated in the contour creation module 1108 can be generated on a processor in the distributed computing system 102. The protocol guide 402 can be generated by processors either in the servers 104 or on the user device 108.

Coupled to the translucent image creation module 1110 is a display protocol guide module 1112. The display protocol guide module 1112 can be activated once the user is required to take one of the subsequent images 702 of FIG. 7 according to the protocol 204.

When a user is prompted to take one of the subsequent images 702 in accordance with the protocol 204, the display protocol guide module 1112 will retrieve the contour 408 and the translucent image 406 stored on the distributed computing system 102 either in the servers 104 or on the user device 108 and display the contour 408 and the translucent image 406 on the user interface 404 of FIG. 4 in the user device 108. Coupled to the display protocol guide module 1112 is an acquire subsequent image module 1114. During activation of the acquire subsequent image module 1114, the protocol guide 402 will be displayed on the user device 108 along with the actual image 502 of FIG. 5.

It is contemplated that the protocol definition module 1102 can also display the actual image 502. The acquire subsequent image module 1114 can be triggered by the user to save the subsequent image 702 when the user believes the actual image 502 is in accordance with the protocol 204 displayed by the protocol guide 402.

The protocol guide 402 can be used to signal compliance with the protocol 204 by flashing the contour 408, changing the contour's 408 color, or other suitable means. Alternatively, the subsequent image 702 could be acquired and stored automatically once the user aligns the actual image 502 with the protocol guide 402. The subsequent image 702 is first acquired by the imaging uniformity system 100 according to the protocol 204 defined in the protocol definition module 1102 and stored in a memory storage on the distributed computing system 102 either in the servers 104 or on the user device 108.

Coupled to the acquire subsequent image module 1114 is a subsequent control image module 1116. During the subsequent control image module 1116 the user will be instructed to acquire the control image 302 for the subsequent image 702.

The control image 302 for the subsequent image 702 will enable the subsequent image 702 to be color balanced. The subsequent image 702 can be color balanced using a processor in the distributed computing system 102. The protocol guide 402 can be generated by processors either in the servers 104 or on the user device 108. It is contemplated that the contour creation module 1108 and the translucent image creation module 1110 could be invoked again after the acquire subsequent image module 1114 module to prepare the contour 408 and the translucent image 406 based on the subsequent image 702.

Once the subsequent image 702 is acquired the subsequent image 702 can be stored on the distributed computing system 102 either in the servers 104 or on the user device 108. The acquire subsequent image module 1114 can be invoked along with the display protocol guide module 1112 and the subsequent control image module 1116 as required to form the series dictated by the protocol and described with respect to FIGS. 9 and 10.

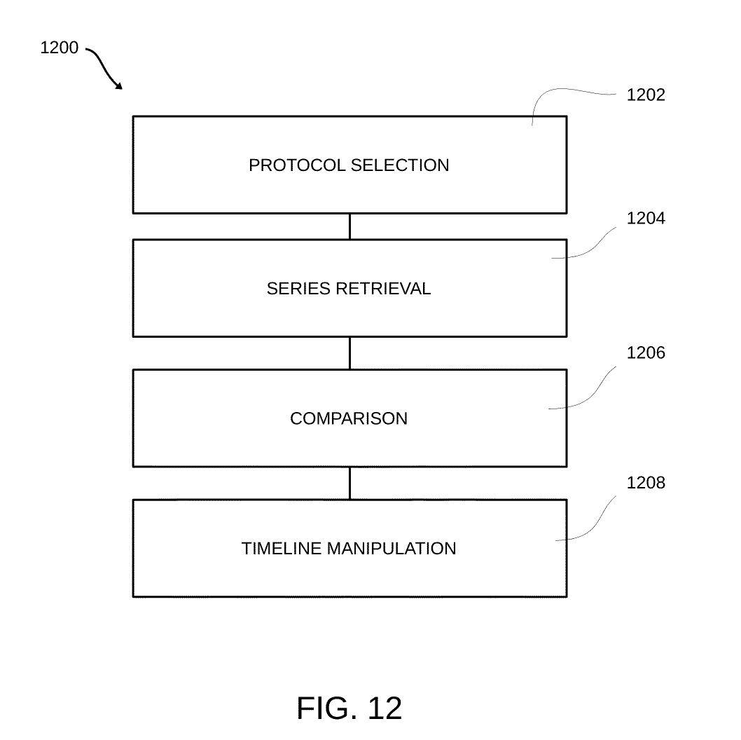

Referring now to FIG. 12, therein is shown an exemplary method of operation 1200 of the imaging uniformity system 100 of FIG. 1. The method of operation 1200 includes a protocol selection module 1202. The protocol selection module 1202 can allow a user to select the protocol 204 of FIG. 2 to be viewed.

During the protocol selection module 1202, a user may select one of the protocols 204 for a specific subject 122 corresponding to a predetermined set of poses or movements. It is contemplated that the protocol selection module 1202 can include various security features, such as requiring a username and password, to preserve the subject's 122 of FIG. 1 confidentiality and comply with privacy laws.

For instance, doctors that have not been given permissions to view a subject's data, cannot access subject or image data associated with that subject 122. Permissions can be based on roles, which can include doctor, health professionals, care team members, or subject.

It is contemplated that the imaging uniformity system 100 of FIG. 1 can also include a database of clinicians which can be used to assign a particular physician to a particular subject 122 and the subject's 122 associated images 120. In this way, it is possible for the physician or other care provider can share the images 120 with other health care providers such as peers or colleagues, for a consult. Physician data that can be associated can include name, address, phone, website, license number, degree and specialty. Specialties can include dermatology, emergency medicine, or oncology.

Once the protocol 204 is selected a series retrieval module 1204 will gather all the images 120 of FIG. 1 within the selected protocol 204 for display on the user device 108. Coupled to the series retrieval module 1204 is a comparison module 1206. The comparison module 1206 can be used to present the images 120 within the comparison panes 904 of FIG. 9 or 1004 of FIG. 10 for analysis and diagnosis by a physician.

The comparison module 1206 can display the images 120 as still images or as video as described with regard to FIGS. 9 and 10. Once the images 120 are displayed on the user device 108 by the comparison module 1206 a timeline manipulation module 1208 may be invoked by a user to view different images 120 along the timeline 906 of FIG. 9 or 1006 of FIG. 10.

Thus, it has been discovered that the imaging uniformity system furnishes important and heretofore unknown and unavailable solutions, capabilities, and functional aspects.

The resulting configurations are straightforward, cost-effective, uncomplicated, highly versatile, accurate, sensitive, and effective, and can be implemented by adapting known components for ready, efficient, and economical manufacturing, application, and utilization.

While the imaging uniformity system has been described in conjunction with a specific best mode, it is to be understood that many alternatives, modifications, and variations will be apparent to those skilled in the art in light of the preceding description.

Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. An imaging uniformity method comprising:
acquiring an initial image based on a protocol;
generating a protocol guide based on the initial image;
displaying the protocol guide overlaying an actual image; and
acquiring a subsequent image of the actual image, and the subsequent image being in alignment with the protocol guide.

2. The method of claim 1 wherein generating the protocol guide includes generating a contour, a translucent image, or a combination thereof.

3. The method of claim 1 further comprising adjusting a color balance of the subsequent image using a control image.

4. The method of claim 1 wherein acquiring the subsequent image includes acquiring multiple subsequent images in accordance with the protocol, the multiple subsequent images forming a series.

5. The method of claim 4 further comprising:
displaying one of the multiple subsequent images taken at a first time in a left comparison pane; and
displaying another of the multiple subsequent images taken at a second time in a right comparison pane, and with the first time and the second time being different.

6. The method of claim 5 further comprising displaying the multiple subsequent images within the series by scrolling through a timeline.

7. The method of claim 5 wherein displaying the multiple subsequent images includes displaying videos on the left comparison pane and on the right comparison pane moving in synchronization.

8. A computer readable medium, useful in association with a processor, including instructions configured to:
acquire an initial image based on a protocol;
generate a protocol guide based on the initial image;
display the protocol guide overlaying an actual image; and
acquire a subsequent image of the actual image, and the subsequent image being in alignment with the protocol guide.

9. The computer readable medium of claim 8 wherein the instructions configured to generate the protocol guide includes instructions to generate a contour, a translucent image, or a combination thereof.

10. The computer readable medium of claim 8 further comprising instructions configured to adjust a color balance of the subsequent image using a control image.

11. The computer readable medium of claim 8 wherein the instructions configured to acquire the subsequent image includes instructions configured to acquire multiple subsequent images in accordance with the protocol, the multiple subsequent images forming a series.

12. The computer readable medium of claim 11 further comprising instructions configured to:
display one of the multiple subsequent images taken at a first time in a left comparison pane; and
display another of the multiple subsequent images taken at a second time in a right comparison pane, and with the first time and the second time being different.

13. The computer readable medium of claim 12 further comprising instructions configured to display the multiple subsequent images within the series by scrolling through a timeline.

14. The computer readable medium of claim 12 wherein the instructions configured to display the multiple subsequent images includes instructions configured to display videos on the left comparison pane and on the right comparison pane moving in synchronization.

15. An imaging uniformity apparatus comprising:
a memory storage having an initial image based on a protocol stored thereon;
a processor configured to generate a protocol guide based on the initial image;
a user interface configured to display the protocol guide overlaying an actual image; and
wherein the memory storage includes a subsequent image of the actual image stored thereon, and the subsequent image being in alignment with the protocol guide.

16. The apparatus of claim 15 wherein the processor is configured to generate a contour, a translucent image, or a combination thereof.

17. The apparatus of claim 15 wherein the processor is configured to adjust a color balance of the subsequent image using a control image.

18. The apparatus of claim 15 wherein the memory storage having the subsequent image stored thereon includes multiple subsequent images in accordance with the protocol stored thereon, the multiple subsequent images forming a series.

19. The apparatus of claim 18 wherein the user interface is configured to display:
one of the multiple subsequent images taken at a first time in a left comparison pane; and
another of the multiple subsequent images taken at a second time in a right comparison pane, and with the first time and the second time being different.

20. The apparatus of claim 19 wherein the user interface is configured to display the multiple subsequent images within the series by scrolling through a timeline.
